(19) United States
(12) Patent Application Publication
(10) Pub. No.: US 2019/0163157 A1
(43) Pub. Date: May 30, 2019

(54) METHOD FOR MONITORING A CONDENSOR PRESSURE PROTECTION CURVE WITH A POLYGON FUNCTION

(71) Applicant: Siemens Aktiengesellschaft, Munich (DE)

(72) Inventors: Andreas Pahl, Düsseldorf (DE); Michael Görtz, Essen (DE)

(73) Assignee: Siemens Aktiengesellschaft, Munich (DE)

(21) Appl. No.: 16/098,989

(22) PCT Filed: Apr. 18, 2017
(86) PCT No.: PCT/EP2017/059124

§ 371 Date: Nov. 5, 2018

(30) Foreign Application Priority Data
May 9, 2016 (EP) 16168700.9

(51) Int. Cl. G05B 19/05; G05B 19/04

(52) U.S. Cl. CPC G05B 19/058; G05B 2219/14006; G05B 19/054; G05B 19/041

(57) ABSTRACT

A method for monitoring a condenser pressure protection curve with a polygon function of a turbine using an SPS safety monitoring system, includes reading a first measurement value and a second measurement value, standardizing the second measurement value to a value scale of the first measurement value using a standardizing module of the SPS safety monitoring system, comparing the first measurement value with the standardized second measurement value using a comparison module of the SPS safety monitoring system, and generating an output signal in response to the standardized second measurement value exceeding the first measurement value.

### CROSS REFERENCE TO RELATED APPLICATIONS

This application is the US National Stage of International Application No. PCT/EP2017/059124 filed Apr. 18, 2017, and claims the benefit thereof. The International Application claims the benefit of European Application No. EP16168700 filed May 9, 2016. All of the applications are incorporated by reference herein in their entirety.

### FIELD OF INVENTION

The invention relates to a method for monitoring a condenser pressure protection curve with a polygon function. The invention further relates to a PLC safety monitoring system for carrying out such a method and a turbine with such a PLC safety monitoring system.

### BACKGROUND OF INVENTION

The operating safety is increased through the monitoring of a condenser pressure protection curve with a polygon function for monitoring a pressure of a condenser of a turbine, such as a steam turbine.

A PLC safety monitoring system is used for monitoring the condenser pressure protection curve. A PLC is to be understood here as a device employed for controlling or regulating a plant and which is programmed on a digital basis.

To monitor a condenser pressure protection curve it is necessary to model a polygon function that has, in segments, a ramp segment. A PLC controller, however, does not have a module for modeling a complex polygon function of this sort with a ramp segment. With comparator function blocks of a PLC controller a multi-stage function can be emulated, if needs be, using a plurality of comparator blocks. This, however, leads to a large number of comparator function blocks and even then to an unsatisfactory approximation to a polygon function with a ramp segment.

### SUMMARY OF INVENTION

An object of the invention, therefore, is to indicate a way in which a condenser pressure protection curve can be better monitored with a polygon function at low expense.

The method according to the invention for monitoring a condenser pressure protection curve with a polygon function of a turbine using a PLC safety monitoring system comprises the steps of: reading in a first measurement value and a second measurement value, normalizing the second measurement value to a value scale of the first measurement value using a normalizing module of the PLC safety monitoring system, comparing the first measurement value with the normalized second measurement value using a comparator module of the PLC safety monitoring system, and generating an output signal in response to the normalized second measurement value exceeding the first measurement value, wherein the first measurement value X1 and the second measurement value X2 change synchronously, wherein the first measurement value X1 and the second measurement value X2 are pressure measurement values.

A ramp segment of the polygon function of the condenser pressure protection curve is thus, for example, modeled using a simple comparator module, while the second measurement value represents the continuously changing value in the ramp segment, and thus illustrates the comparison value in this segment. A polygon function with a ramp segment can thus be modeled in a surprisingly simple manner.

According to one form of embodiment, the second measurement value is multiplied with a predetermined value by a multiplier of the normalization module. It is possible in this way to take account of the fact that the first measurement value and the second measurement value exhibit different gradients and/or temporal dynamics depending on their input values. The second measurement value is, in other words, adapted to the first measurement value.

According to a further form of embodiment, an offset is added by an adder of the normalization module. It is possible in this way to take account of the fact that the first measurement value and the second measurement value differ from one another by an offset. The second measurement value is, in other words, adapted to the first measurement value. The safety can thus be further increased in that a safety reserve can be taken into account by adding on an offset.

According to a further form of embodiment, an input pressure value of the turbine is read in as the first measurement value. A value that is particularly easy to capture using measuring technology is thus used.

According to a further form of embodiment, a condenser pressure value of the turbine is read in as the second measurement value. A value that is particularly easy to capture using measuring technology is thus used.

A PLC safety monitoring system for carrying out such a method and a turbine with such a PLC safety monitoring system belong further to the invention.

### BRIEF DESCRIPTION OF THE DRAWINGS

A form of embodiment of the method according to the invention is explained below with reference to the appended schematic drawings. Here:

FIG. 1 shows a schematic illustration of a condenser pressure protection curve,

FIG. 2 shows a schematic illustration of a part of a PLC safety monitoring system for monitoring the condenser pressure protection curve illustrated in FIG. 1, and

FIG. 3 shows a schematic illustration of a further part of a PLC safety monitoring system for monitoring the condenser pressure protection curve illustrated in FIG. 1.

### DETAILED DESCRIPTION OF INVENTION

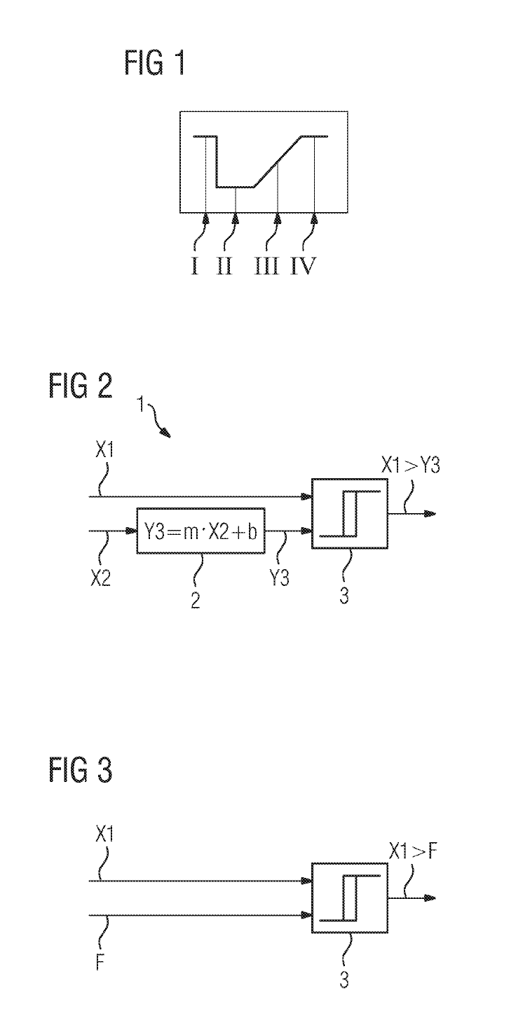

Reference is first made to FIG. 1.

An example of a condenser pressure protection curve with a polygon function is illustrated, as is for example used for safety monitoring of a turbine, e.g. a steam turbine.

The condenser pressure protection curve illustrated in FIG. 1 has a first segment I with a constant range, a second segment II with a second constant range, a third segment III with a continuously rising progression, and a fourth segment IV with a third constant range. While the values are the same in the first segment I and in the fourth segment IV, the second segment II has a value that is smaller than the values of the first segment I and of the fourth segment IV. The third segment III on the other hand illustrates a ramp segment that starts at the value of the second segment II and finishes at the value of the fourth segment IV.

Reference is now additionally made to FIG. 2.

A part of a PLC safety monitoring system 1 for modeling the third segment III for monitoring the condenser pressure protection curve shown in FIG. 1 is illustrated.

This part of the PLC safety monitoring system 1 comprises, in the present exemplary embodiment, a normalization module 2 and a comparator module 3 as function blocks.

In the present exemplary embodiment, the normalization module 2 comprises a multiplier for multiplying with a predetermined value m, and an adder for adding an offset b.

The PLC safety monitoring system 1 and/or the normalization module 2 and/or the comparator module 3 comprise, in the present exemplary embodiment, hardware and/or software components for this purpose.

In the present exemplary embodiment, an inlet pressure value of a turbine is supplied as the first measurement value X1 to the comparator module 3 after it has been read in by the PLC safety monitoring system 1, while a condenser pressure value of the turbine is read in as the second measurement value X2 to the normalization module 2 after it, too, has been read in by the PLC safety monitoring system 1.

The multiplier of the normalization module 2 multiplies the second measurement value X2 with the predetermined value m in order thus to achieve an adaptation of the gradient in the ramped third region III. The adder of the normalization module 2 then adds the offset b, for example a value of 0.3 bar.

The output value Y3 is then fed to the comparator module 3. The comparator module 3 then compares the output value Y3 with the first measurement value X1 and for example supplies an output signal of logical one if the first measurement value X1 is larger than the output value Y3. Otherwise the comparator module 3 supplies an output signal of logical zero.

Since the first measurement value X1 and the second measurement value X2 change synchronously, the second measurement value X2, after being adapted with the normalization module 2, forms a continuously adapting boundary in the ramped third segment III. Reference is now additionally made to FIG. 3.

A further part of the PLC safety monitoring system 1 for modeling the first segment I, the second segment II or the fourth segment IV for monitoring the condenser pressure protection curve shown in FIG. 1 is illustrated.

This part consists of a further comparator module 3 as a function block to which a fixed value F is supplied as well as the first measurement value X1. The comparator module 3 then compares the fixed value F with the first measurement value X1 and for example supplies an output signal of logical one if the first measurement value X1 is larger than the fixed value F. Otherwise the comparator module 3 supplies an output signal of logical zero.

A condenser pressure protection curve with a polygon function can thus be modeled both in constant segments as well as in ramped segments with a PLC safety monitoring system with only simple comparator modules.

Although the invention has been more closely illustrated and described in more detail through the preferred exemplary embodiment, the invention is not restricted by the disclosed examples, and other variations can be derived from this by the person skilled in the art without leaving the scope of protection of the invention.

1. A method for monitoring a condenser pressure protection curve with a polygon function of a turbine using a PLC safety monitoring system, comprising:
reading in a first measurement value and a second measurement value,
normalizing the second measurement value to a value scale of the first measurement value using a normalizing module of the PLC safety monitoring system, and
generating an output signal in response to the normalized second measurement value exceeding the first measurement value,
wherein the first measurement value and the second measurement value change synchronously,
wherein the first measurement value and the second measurement value are pressure measurement values.

2. The method as claimed in claim 1,
wherein the second measurement value is multiplied with a predetermined value by a multiplier of the normalization module.

3. The method as claimed in claim 1,
wherein an offset is added with an adder of the normalization module.

4. The method as claimed in claim 1,
wherein an inlet pressure value of the turbine is read in as the first measurement value.

5. The method as claimed in claim 1,
wherein a condenser pressure value of the turbine is read in as the second measurement value.

6. A PLC safety monitoring system configured for monitoring a condenser pressure protection curve with a polygon function of a turbine, and configured for reading in a first measurement value and a second measurement value, the PLC safety monitoring system comprising:
a normalization module configured for normalizing the second measurement value to a value scale of the first measurement value,
a comparator module configured for comparing the first measurement value with the normalized second measurement value, and configured for generating an output signal in response to capturing the first measurement value being exceeded by the normalized second measurement value,
wherein the first measurement value and the second measurement value change synchronously,
wherein the first measurement value and the second measurement value are pressure measurement values.

7. The PLC safety monitoring system as claimed in claim 6,
wherein the normalization module comprises a multiplier for multiplying the second measurement value with a predetermined value.

8. The PLC safety monitoring system as claimed in claim 6,
wherein the normalization module comprises an adder for adding an offset.

9. A turbine comprising:
a PLC safety monitoring system as claimed in claim 6.

10. The turbine as claimed in claim 9,
wherein the second measurement value is captured with a condenser pressure sensor of the turbine.
